(19) United States
(12) Patent Application Publication
(10) Pub. No.: US 2010/0197342 A1
(43) Pub. Date: Aug. 5, 2010

(54) MOBILE TERMINAL AND METHOD FOR CONTROLLING THE MOBILE TERMINAL

(75) Inventor: Kwang-Won LEE, Seoul (KR)

Correspondence Address: H.C. PARK & ASSOCIATES, PLC, 8500 LEESBURG PIKE, SUITE 7500, VIENNA, VA, 22182, US

(73) Assignee: Pantech Co., Ltd., Seoul (KR)

(21) Appl. No.: 12/689,069

(22) Filed: Jan. 18, 2010

(30) Foreign Application Priority Data
Jan. 30, 2009 (KR) 10-2009-0007369

(51) Int. Cl. H04M 1/00

(52) U.S. Cl. 455/550.1

(57) ABSTRACT

A mobile terminal includes a case, a key module to be moveable between a first point and a second point along the case; a mode identification unit to identify a position of the key module as the first point or the second point, and to identify mode information associated with the position of the key module; and an application drive unit to drive an application based on the mode information. A method for controlling a mobile terminal includes verifying a position of a moveable key module as a first point or a second point along a case of the mobile terminal, identifying mode information associated with the position of the moveable key module, and driving an application based on the mode information.

### CROSS-REFERENCE TO RELATED APPLICATION

This application claims priority from and the benefit of Korean Patent Application No. 10-2009-0007369, filed on Jan. 30, 2009, which is hereby incorporated by reference for all purposes as if fully set forth herein.

### BACKGROUND OF THE INVENTION

1. Field of the Invention

Embodiments of the present invention relate to a mobile terminal and a method for controlling the mobile terminal, and more specifically, a mobile terminal and a method for controlling functions of the mobile terminal using a multi-positional key module.

2. Discussion of the Background

With development of communication technologies, a mobile terminal including various functions such as an image photographing function using an installed digital camera, a media file play function, a satellite/terrestrial broadcasting receiver function, a game function, and the like, is widely used. For example, the mobile terminal may be a cellular phone, a personal digital assistant (PDA), and the like.

In addition, as a mobile Internet environment is advancing toward a wideband code division multiple access (WCDMA) based 3^{rd} generation (3G) environment, mobile terminals with browsers are increasing and an increasing number of users are using a video call service, an auto-roaming service, and the like.

FIG. 1 is a perspective view illustrating a conventional mobile terminal 100.

As shown in FIG. 1, the conventional mobile terminal 100 includes various types of key buttons on its left side and right side to control functions of the mobile terminal 100. The mobile terminal 100 includes the key buttons and connectors for various function operations, for example, a hold key 110, a multi-tasking key 120, a video call/camera key 130, volume up/down keys 141 and 142, a stereo ear mike/external connector connecting terminal 150, and the like.

As described above, as functions of a mobile terminal become more complex, more key buttons, for example, a side key, for function operations are required. However, more key buttons is contradictory to a slim and simple design that is popular for the mobile terminal.

In particular, in the case of a currently popular touch phone, a key button such as a hold key is separately provided on a side of the touch phone in order to prevent a malfunction caused by touching a screen while in an idle status. In addition, since the touch phone includes key buttons for various function operations, a design of the touch phone may become complex and need many parts, which may result in an increase in manufacturing costs.

Accordingly, there is a need for a technology that may integrate, into a single key module, key buttons provided for various function operations of a mobile terminal, and thereby perform maximum operations with a minimum number of parts.

### SUMMARY OF THE INVENTION

Exemplary embodiments of the present invention provide a mobile terminal that may integrate, into a single key module, key buttons provided for various function operations of a mobile terminal, and thereby may perform multiple operations. Exemplary embodiments of the present invention also provide a method for controlling the mobile terminal.

Additional features of the invention will be set forth in the description which follows, and in part will be apparent from the description, or may be learned by practice of the invention.

An exemplary embodiment of the present invention discloses a mobile terminal including: a case, a key module to be moveable between a first point and a second point along the case; a mode identification unit to identify a position of the key module as the first point or the second point, and to identify mode information associated with the position of the key module; and an application drive unit to drive an application based on the mode information.

An exemplary embodiment of the present invention discloses a method for controlling a mobile terminal, the method including: verifying a position of a moveable key module as a first point or a second point along a case of the mobile terminal; identifying mode information associated with the position of the moveable key module; and driving an application based on the mode information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view illustrating a conventional mobile terminal.

FIG. 2 is a block diagram illustrating a mobile terminal according to an exemplary embodiment of the present invention.

FIG. 3 is a diagram illustrating an example of a database used in the mobile terminal of FIG. 2.

FIG. 4 is a perspective view illustrating a mobile terminal according to an exemplary embodiment of the present invention.

FIG. 5 is a cross-sectional view illustrating a mobile terminal according to an exemplary embodiment of the present invention.

FIG. 6 is a perspective view illustrating a key module of a mobile terminal according to an exemplary embodiment of the present invention.

FIG. 7 is a perspective view illustrating a mobile terminal according to an exemplary embodiment of the present invention.

FIG. 8 is a perspective view illustrating a mobile terminal having a key module located at a first point according to an exemplary embodiment of the present invention.

FIG. 9 is a cross-sectional view illustrating a mobile terminal having a key module located at a first point according to an exemplary embodiment of the present invention.

FIG. 10 is a perspective view illustrating a mobile terminal having a key module located at a second point according to an exemplary embodiment of the present invention.

FIG. 11 is a perspective view illustrating a mobile terminal having a key module located at a third point according to an exemplary embodiment of the present invention.

FIG. 12 is a flowchart illustrating a method for controlling a mobile terminal according to an exemplary embodiment of the present invention.

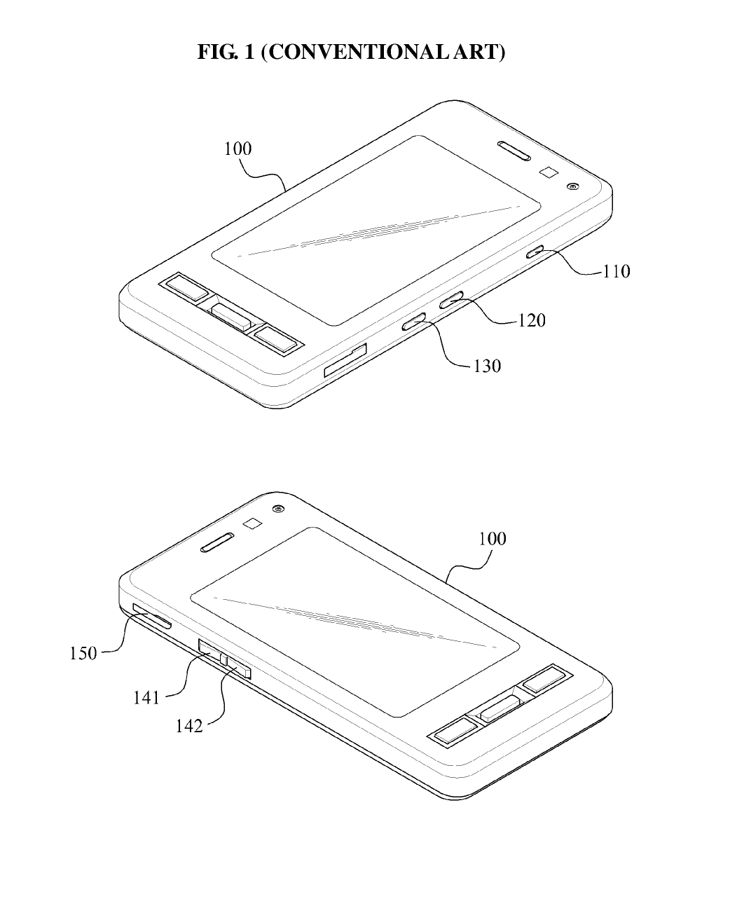

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

A mobile terminal according to exemplary embodiments of the present invention is disclosed below with reference to the accompanying drawings.

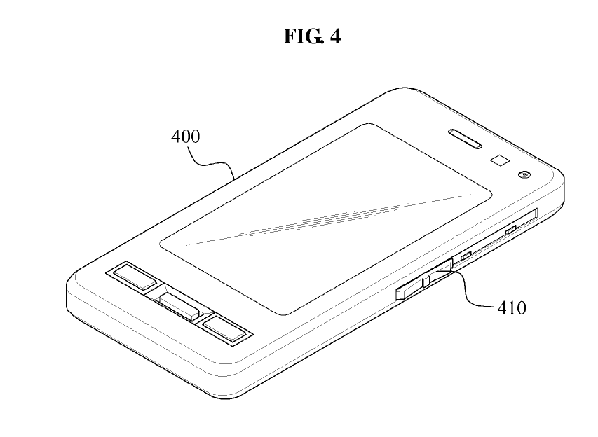

FIG. 4 is a perspective view illustrating a mobile terminal 400 according to an exemplary embodiment of the present invention.

Referring to FIG. 4, the mobile terminal 400 includes a key module 410 to slide along a side of a case of the mobile terminal 400. The mobile terminal 400 may drive a different application according to mode information associated with each point along the side of the case where the key module 410 is located based on the sliding.

Although the mobile terminal 400 is shown as having a single-body case, a key module according to an exemplary embodiment of the invention could be implemented into a sliding-style mobile terminal, a folder-style mobile terminal, a candy bar-style mobile terminal, or another style of mobile terminal case. Where the mobile terminal includes more than one case, the location of the key module is not limited. For example, in a folder-style mobile terminal, a key module could be arranged on the upper portion of the mobile terminal near the display or the lower portion near the keypad. Further, although the location of the key module 410 is shown to be on a side of the case of the mobile terminal 400, the location could be along a different surface of the case. Moreover, although the key module 410 is shown as moveable by being slid along the case, a key module according to another exemplary embodiment could be moveable in a different manner, such as by being rotated or flipped. Additionally, these variations may be applied to all other embodiments described in the specification.

According to an exemplary embodiment of the present invention, multiple key buttons provided for various function operations in a conventional mobile terminal may be integrated into the single key module 410 of the mobile terminal 400. In additional, the mobile terminal 400 may identify mode information associated with each point along the side of the case where the key module 410 is located according to a terminal user's sliding operation on the mobile terminal 400, and drive an application corresponding to the identified mode information. Through this, the mobile terminal 400 may perform multiple functions via the single key module 410 according to a position of the single key module 410.

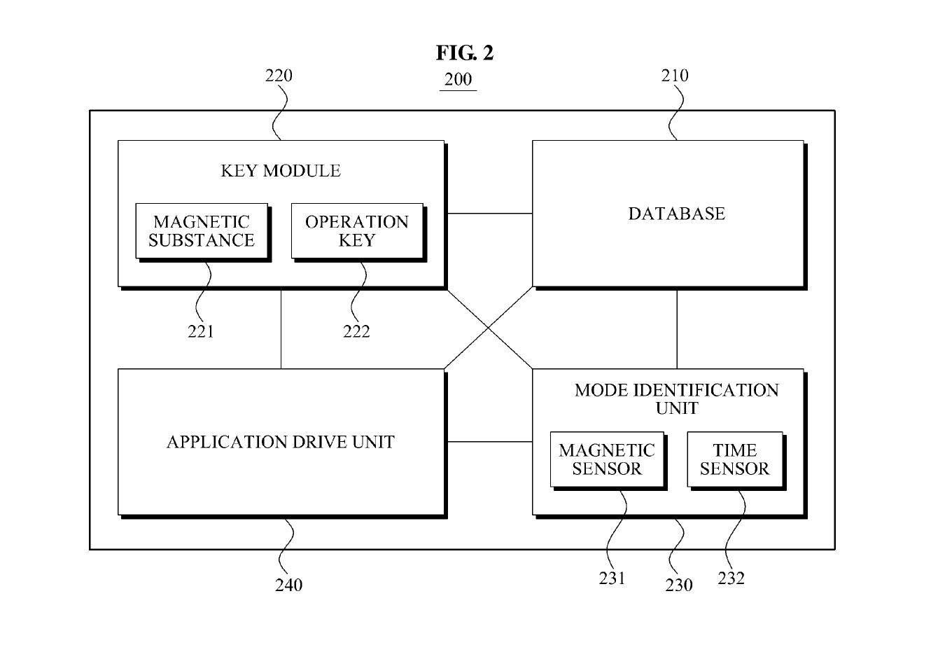

FIG. 2 is a block diagram illustrating a mobile terminal 200 according to an embodiment of the present invention.

Referring to FIG. 2, the mobile terminal 200 may include a database 210, a key module 220, a mode identification unit 230, and an application drive unit 240.

The key module 220 is arranged to slide along a side of a case of the mobile terminal 200. The key module 220 may include a magnetic substance 221 and an operation key 222 including an upper direction key and a lower direction key.

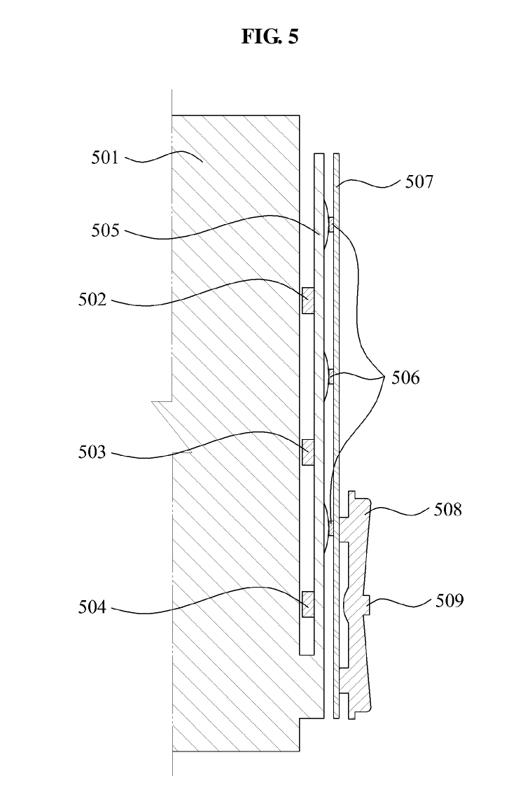

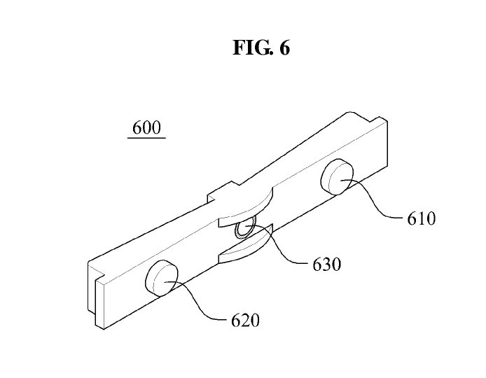

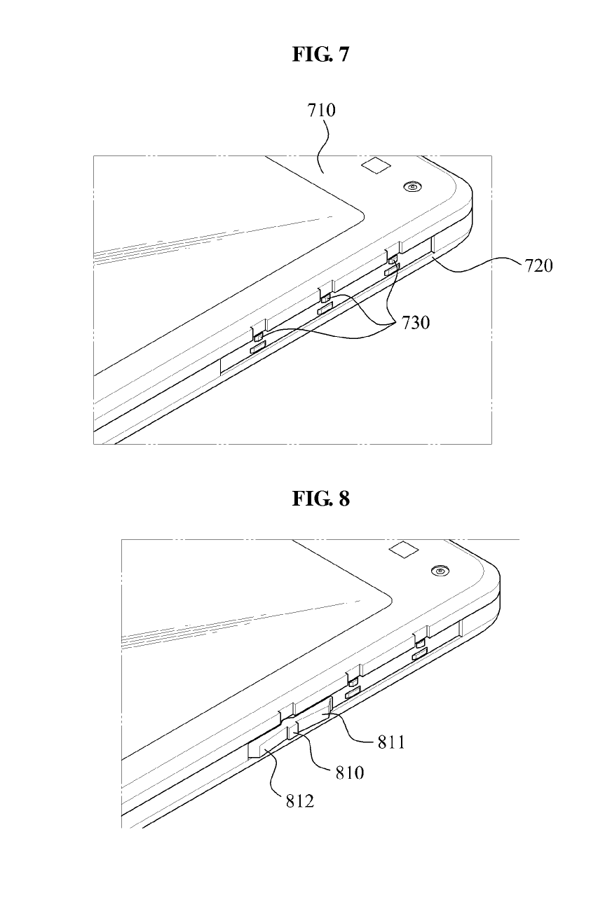

Hereinafter, the key module 220 will be described in more detail with reference to FIG. 5, FIG. 6, and FIG. 7.

FIG. 5 is a cross-sectional view illustrating a mobile terminal according to an embodiment of the present invention.

As shown in FIG. 5, the key module 220 may include a single side key 508 that may slide on a side of the mobile terminal 200.

The mobile terminal 200 may further include a main printed circuit board (PCB) 501, magnetic sensors 502, 503, and 504 to sense a magnetic substance 509 of the key module 220, a key flexible PCB (FPCB) 505, a dome sheet 506, and a PC sheet 507 to reduce the risk of an external substance from entering the inside.

FIG. 6 is a perspective view illustrating a key module of a mobile terminal according to an embodiment of the present invention.

As shown in FIG. 6, the key module 220 may be embodied as a single side key 600 to slide on a side of the mobile terminal 200.

A magnetic substance 630 may be provided on a center of the side key 600. The magnetic sensors 502, 503, and 504 shown in FIG. 5 may sense the magnetic sensor 630 to verify a current point of the side key 600, that is, a point along a side of a case where the side key 600 is arranged. This point will be referred to as a “verify point.”

The side key 600 may include the operation key including an upper direction key 610 and a lower direction key 620. Based on the terminal user's pressing of the upper direction key 610 or the lower direction key 620, the mobile terminal 200 may control an application that is driven based on mode information associated with the verify point.

FIG. 7 is a perspective view illustrating a mobile terminal according to an embodiment of the present invention.

The mobile terminal 200 may include multiple fixing units 730 with respect to an upper portion 710 and a lower portion 720 of a case in order to set a location of the side key 600 on a side of the case.

The mode identification unit 230 functions to identify a point along the side of the case where the key module 220 is located according to the sliding, and to identify mode information associated with the identified point.

The mode identification unit 230 may include a magnetic sensor 231 arranged along the side of the case to sense the magnetic substance 221 included in the key module 220, and a time sensor 232 to sense whether the magnetic substance 221 is maintained at a point for a predetermined period of time, and to verify that the key module 220 is located at a corresponding point.

For example, the database 210 may register mode information corresponding to a point along the side of the case. The mode identification unit 230 may identify mode information, registered in the database 210, corresponding to a point where the sliding of the key module 220 is arranged.

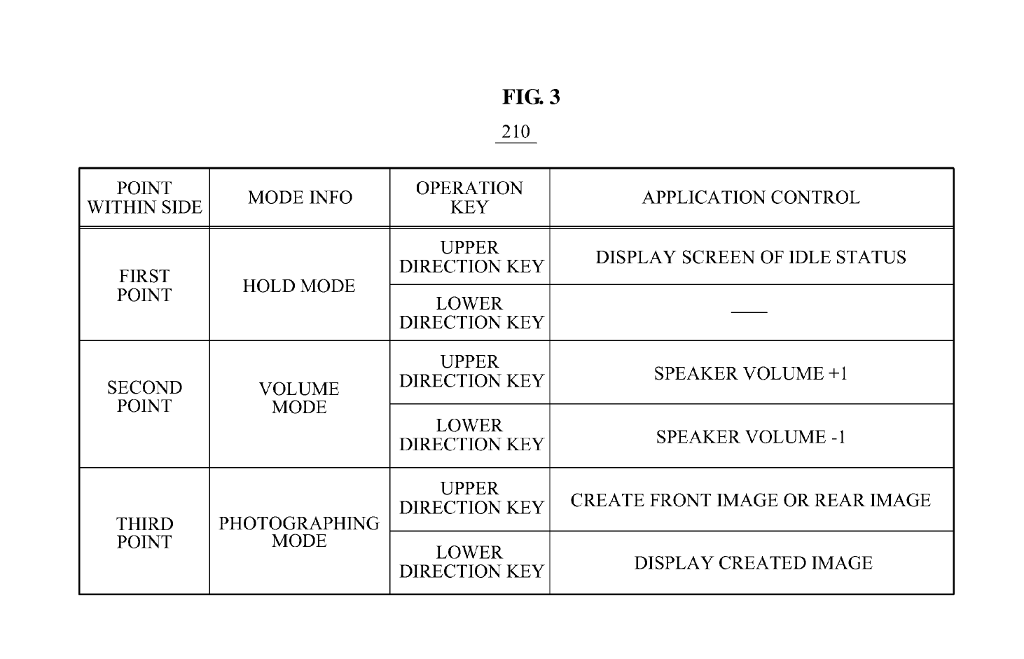

Hereinafter, a process of identifying the mode information registered in the database 210 will be described in more detail with reference to FIG. 3.

FIG. 3 is a diagram illustrating an example of the database 210 used in the mobile terminal 200 of FIG. 2.

For example, the database 210 may register, as mode information, a ‘hold mode’ in association with a ‘first point’ along the side of the case. Here, the hold mode may prevent a malfunction caused by an inadvertent screen touch while the mobile terminal 200 is in an idle status.

Accordingly, if the key module 220 is located at the first point along the side of the case, the hold mode of the mobile terminal 200 may be set by driving a hold application.

Also, the database 210 may register a detailed control about a ‘display screen of an idle status’ in the hold application, in association with an ‘upper direction key’ included in the key module 220.

Accordingly, if the mobile terminal 200 is identified as being in the hold mode, the terminal user may operate the upper direction key of the key module 220. This will cause the mobile terminal 200 to display a screen of the idle status.

Specifically, even though the hold mode is set to prevent the malfunction caused by the inadvertent screen touch in the idle status, the terminal user may operate the upper direction key of the key module 220 to verify the screen of the idle status. This screen may include, for example, a date, a time, a battery status, and the like.

Although not shown, the database 210 may register an additional detailed control with respect to the hold application using a ‘lower direction key’ included in the key module 220, and may also prohibit an additional registration for operating the hold mode.

As another example, the database 210 may register, as mode information, a ‘volume mode’ in association with a ‘second point’ along the side of the case. Here, the volume mode may be used to adjust a speaker volume in a calling/called status of the mobile terminal 200, or in a multimedia playback status.

If the key module 220 is located at the second point along the side of the case, the volume mode of the mobile terminal 200 may be set by driving a volume application.

Also, the database 210 may register a detailed control about ‘speaker volume +1’ in the volume application in association with the ‘upper direction key’ included in the key module 220. The database 210 may register a detailed control about ‘speaker volume −1’ in the volume application in association with the ‘lower direction key’ included in the key module 220.

Accordingly, if the mobile terminal 200 is identified as being in the volume mode, the terminal user may operate the upper direction key of the key module 220 and thereby perform the detailed control of increasing the speaker volume by +1 for each time that the upper direction key is operated, with respect to the volume application driven in the mobile terminal 200. Also, with respect to the volume application driven in the mobile terminal 200, the terminal user may operate the lower direction key of the key module 200 and thereby perform the detailed control of decreasing the speaker volume by −1 for each time that the lower direction key is operated.

Specifically, since it may be difficult to enter a menu screen for adjusting a volume in a conventional terminal, the terminal user of the mobile terminal 200 may control the operation key 222 of the key module 220 including the upper direction key and the lower direction key to adjust a volume.

If the mobile terminal 200 is in an incoming call status, the key module 220 may be moved to the second point along the side of the case whereby the volume application is driven and a call may also be automatically connected in response to driving the volume application. Therefore, the mobile terminal 200 may be automatically changed from the incoming call status to the calling/called status. In the calling/called status, the ‘volume mode’ for adjusting the speaker volume may be set.

As another example, the database 210 may register, as mode information, a ‘photographing mode’ in association with a ‘third point’ along the side of the case. Here, the photographing mode may be used to create an image in a camera-on status of the mobile terminal 200.

Accordingly, if the key module 220 is located at the third point along the side of the case, the photographing mode of the mobile terminal 200 may be set by driving a photographing application.

Also, the database 210 may register a detailed control about an ‘image creation’ in the photographing application in association with the ‘upper direction key’ included in the key module 220. The database 210 may register a detailed control about ‘display the created image on a screen’ in association with the ‘lower direction key’ included in the key module 220.

Here, the database 210 may register a detailed control about creating an image using a front camera or a rear camera in the photographing application in association with the ‘upper direction key’.

Accordingly, if the mobile terminal 200 is identified as being in the photographing mode, the terminal user may operate the upper direction key of the key module 220 and thereby control the photographing application driven in the mobile terminal 200 to readily create an image. Also, the terminal user may operate the upper direction key of the key module 220 to perform a detailed control of changing photographing of the image using the front/rear camera. Also, with respect to the photographing application driven in the mobile terminal 200, the terminal user may operate the lower direction key of the key module 220 and thereby perform a quick view control of displaying the created image on a screen.

Specifically, although it may be difficult to perform an image creation/display/change photographing of the image using the front/rear camera in a camera-on status in a conventional terminal, the terminal user of the mobile terminal 200 may operate the operation key 222 of the key module 220 including the upper direction key or the lower direction key to create the image, to change photographing of the image using the front/rear camera, or to display the created image on the screen.

Alternatively or in conjunction with the foregoing examples, the database 210 may register a detailed control about a ‘zoom function’ in the photographing mode, and the function associated with the ‘upper direction key’ may include zooming in, and the function associated with the ‘lower direction key’ may include zooming out. Further, the detailed controls and mode information associated with the points in the database 210 may be user-selected and customizable.

The application drive unit 240 functions to drive an application upon identifying the mode information.

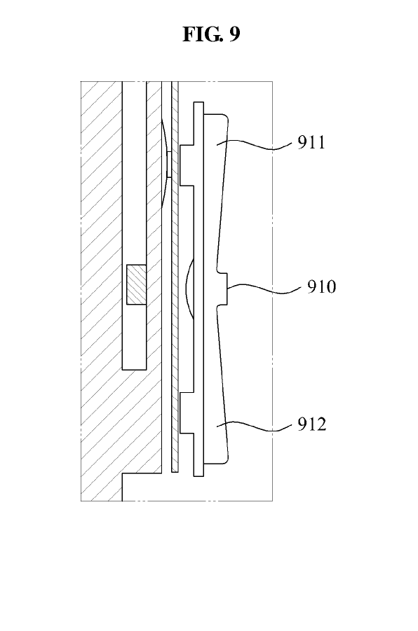

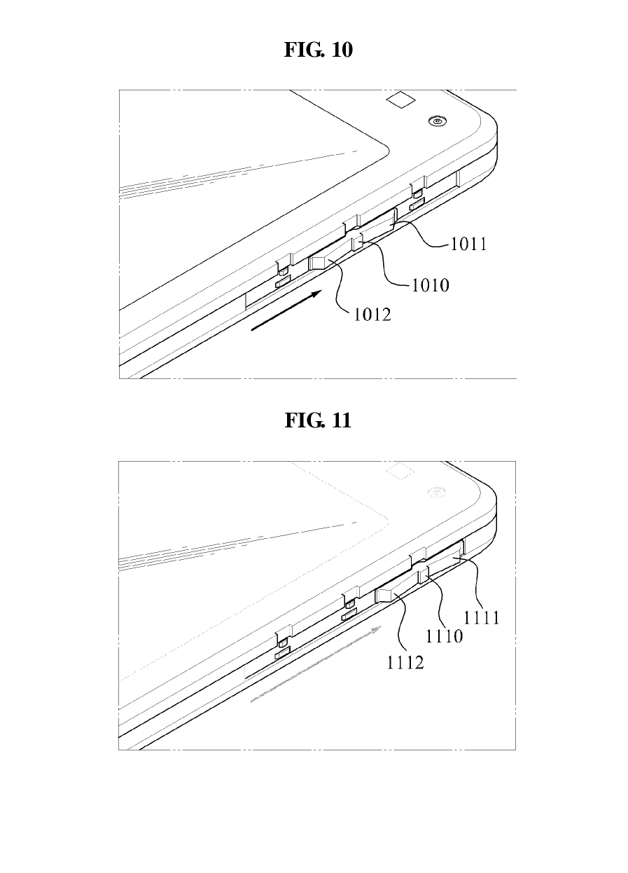

Hereinafter, the application drive unit 240 will be described with reference to FIG. 8, FIG. 9, FIG. 10, and FIG. 11.

FIG. 8 is a perspective view illustrating a mobile terminal having a key module located at a first point according to an exemplary embodiment of the present invention.

For example, if a location of the magnetic substance 221 included in a key module 810, that is, a location of the key module 810 is verified as the first point along the side of the case using the magnetic sensor 231, the mode identification unit 230 may identify mode information associated with the first point as a ‘hold mode’ from the database 210.

If the mode information is identified as the ‘hold mode’, the application drive unit 240 may drive a hold application to set the ‘hold mode’, and may control the hold application to display an idle screen in association with an event occurring due to upper direction key 811 included in the key module 810.

Accordingly, if the mobile terminal 200 is identified as being in the hold mode, the upper direction key 811 of the key module 810 may be controlled by the terminal user and thus the application drive unit 240 may perform a detailed control of displaying a screen of an idle status with respect to the hold application driven in the mobile terminal 200.

Specifically, even though the hold mode is set to prevent the malfunction caused by an inadvertent screen touch in the idle status, the terminal user may control the upper direction key 811 of the key module 810 to readily verify the screen of the idle status, for example, a date, a time, and a battery, in the idle status.

If an additional detailed control with respect to the hold application using the lower direction key 812 is not registered in the database 210, the hold mode may be executed regardless of operating the lower direction key 812. Alternatively, an additional dome sheet 506 such as shown in FIG. 5 could be included to correspond to the location of lower direction key 812 when the key module 810 is in the first position, and the application drive unit 240 may control the hold application to perform a separate function registered in the database 210 due to lower direction key 812.

FIG. 9 is a cross-sectional view illustrating a mobile terminal having a key module located at a first point according to an exemplary embodiment of the present invention.

The mode identification unit 230 may sense a location of the magnetic substance 221 included in the key module 220, that is, the first point along the side of the case, via the magnetic sensor 231 included in a key FPCB 505, to identify the mobile terminal 200 as being in an idle status.

Here, the lower direction key 912 of the key module 220 may cause the mobile terminal 200 to remain in a hold status. If the upper direction key 911 of the key module 220 is operated by the terminal user, the application drive unit 240 may display the screen of the idle status.

FIG. 10 is a perspective view illustrating a mobile terminal having a key module located at a second point according to an exemplary embodiment of the present invention.

If a location of the magnetic substance 221 included in a key module 1010, that is, a location of the key module 1010 is verified as the second point along the side of the case using the magnetic sensor 231, the mode identification unit 230 may identify mode information associated with the second point as a ‘volume mode’ from the database 210.

If the mode information is identified as the ‘volume mode’, the application drive unit 240 may drive a volume application to set the ‘volume mode’, and control the volume application to increase or decrease a speaker volume in association with an event occurring due to depression of an upper direction key 1011 or a lower direction key 1012, respectively, included in the key module 1010.

Accordingly, if the mobile terminal 200 is identified as being in the volume mode, the upper direction key 1011 of the key module 1010 may be controlled by the terminal user and thus the application drive unit 240 may perform a detailed control of increasing the speaker volume by +1 for each time that the upper direction key 1011 is operated, with respect to the volume application driven in the mobile terminal 200. Also, as the lower direction key 1012 of the key module 1010 is operated by the terminal user, the application drive unit 240 may perform a detailed control of decreasing the speaker volume by −1 for each time that the lower direction key 1012 is operated, with respect to the volume application driven in the mobile terminal 200.

Specifically, the terminal user of the mobile terminal 200 may control the upper direction key 1011 or the lower direction key 1012 of the key module 1010 to thereby adjust a volume.

If the mobile terminal 200 is in an incoming call status, the key module 1010 may move to the second point along the side of the case whereby the volume application is driven and a call may be automatically connected in response to driving the volume application. Therefore, the mobile terminal 200 may be automatically changed from the incoming call status to the calling/called status. In the calling/called status, the ‘volume mode’ for adjusting the speaker volume may be set.

FIG. 11 is a perspective view illustrating a mobile terminal having a key module located at a third point according to an exemplary embodiment of the present invention.

If a location of the magnetic substance 221 included in a key module 1110, that is, a location of the key module 1110 is verified as the third point along the side of the case using the magnetic sensor 231, the mode identification unit 230 may identify mode information associated with the third point as a ‘photographing mode’ from the database 210.

If the mode information is identified as the ‘photographing mode’, the application drive unit 240 may drive a photographing application to set the photographing mode, and may control the photographing application to create an image or display the created image on the screen in association with an event occurring due to the depression of an upper direction key 1111 or a lower direction key 1112, respectively, included in the key module 1110.

Accordingly, if the mobile terminal 200 is identified as being in the photographing mode, the upper direction key 1111 of the key module 1110 may be controlled by the terminal user and thus the application drive unit 240 may control the photographing application to create the image or change photographing of the image using the front/rear camera. Also, as the lower direction key 1112 of the key module 1110 is controlled by the terminal user, the application drive unit 240 may perform a detailed control of displaying the created image on the screen, with respect to the photographing application driven in the mobile terminal 200.

Specifically, the terminal user may control the operation key 222 such as the upper direction key 1111 or the lower direction key 1112 of the key module 1110 to readily create the image, to change photographing of the image using the front/rear camera, or to display the created image on the screen.

According to an exemplary embodiment of the present invention, a mobile terminal may integrate, into a single key module sliding along a side of a case, key buttons associated with various function operations. Also, the mode identification unit 230 may identify mode information associated with a point along the side of the case where the key module is located according to a sliding operation of a terminal user, and thereby may perform various functions via the single key module.

Also, according to an embodiment of the present invention, key buttons associated with each function operation may be integrated into a single key module.

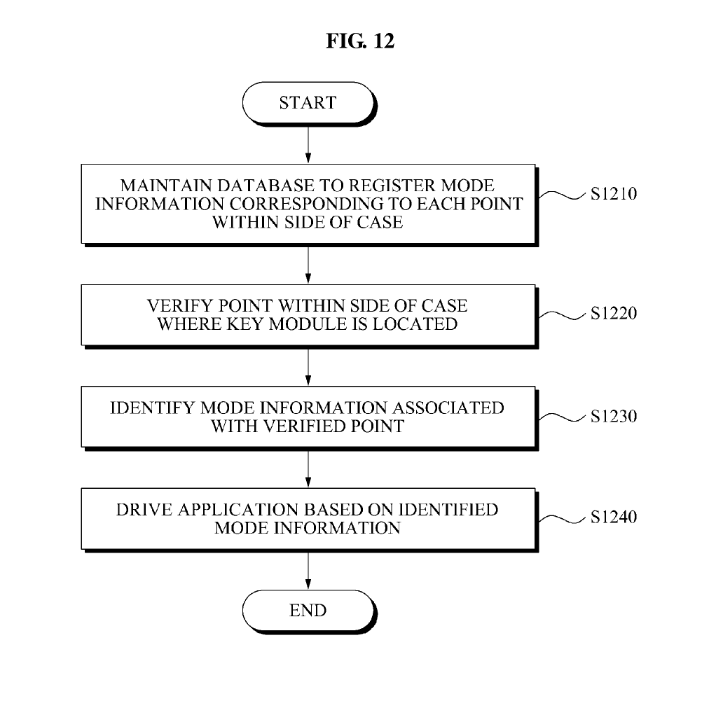

FIG. 12 is a flowchart illustrating a method for controlling a mobile terminal according to an embodiment of the present invention.

The control method may be performed by a mobile terminal according to an exemplary embodiment of the present invention. Hereinafter, the control method will be described in more detail with reference to FIG. 12, and may refer to features shown and described in other drawings described above.

In operation S1210, the mobile terminal 200 may maintain the database 210 to register mode information corresponding to each point along a side of a case.

For example, the database 210 may register, as mode information, a ‘hold mode’ in association with a ‘first point’ along the side of the case, a ‘volume mode’ in association with a ‘second point’ along the side of the case, and a ‘photographing mode’ in association with a ‘third point’ along the side of the case. These modes are described in more detail with reference to FIG. 3 above.

In operation S1220, the mobile terminal 200 may verify the point along the side of the case where the key module 220 is located.

The mode identification unit 230 may sense the magnetic substance 221 included in the key module 220 via the magnetic sensor 231, and may sense, via the time sensor 232, whether the magnetic substance 221 is maintained at a position for a predetermined period of time. Thus, the mode identification unit 230 may determine a verify point.

In operation S1230, the mobile terminal 200 may verify, from the database 210, mode information associated with the verify point.

Referring to FIG. 8, if a location of the magnetic substance 221 included in the key module 810, that is, a location of the key module 810 is verified as a first point along the side of the case using the magnetic sensor 231, the mode identification unit 230 may identify, as a ‘hold mode’ from the database 210, mode information associated with the first point.

Referring to FIG. 10, if a location of the magnetic substance 221 included in the key module 1010, that is, a location of the key module 1010 is verified as a second point along the side of the case using the magnetic sensor 231, the mode identification unit 230 may identify, as a ‘volume mode’ from the database 210, mode information associated with the second point.

Referring to FIG. 11, if a location of the magnetic substance 221 included in the key module 1110, that is, a location of the key module 1110 is verified as a third point along the side of the case using the magnetic sensor 231, the mode identification unit 230 may identify, as a ‘photographing mode’ from the database 210, mode information associated with the third point.

In operation S1240, the mobile terminal 200 may drive an application based on the identified mode information.

Referring to FIG. 8, if the mode information is identified as the ‘hold mode’, the application drive unit 240 may drive a hold application to set the ‘hold mode’, and may control the hold application to display an idle screen in association with an event occurring due to operation of upper direction key 811 and the lower direction key 812 included in the key module 810.

Referring to FIG. 10, if the mode information is identified as the ‘volume mode’, the application drive unit 240 may drive a volume application to set the ‘volume mode’, and control the volume application to increase or decrease a speaker volume in association with an event occurring due to operation of the upper direction key 1011 and the lower direction key 1012 included in the key module 1010.

Referring to FIG. 11, if the mode information is identified as the ‘photographing mode’, the application drive unit 240 may drive a photographing application to set the photographing mode, and may control the photographing application to create an image or display the created image on the screen in association with an event occurring due to the operation of the upper direction key 1111 and the lower direction key 1112 included in the key module 1110.

According to an exemplary embodiment of the present invention, a mobile terminal may integrate, into a single key module able to slide along a case, key buttons associated with various function operations. Also, the mode identification unit 230 may identify mode information associated with a point where the key module is located according to a sliding operation of a terminal user, and thereby perform various functions via the single key module.

Also, according to an exemplary embodiment of the present invention, key buttons associated with each function operation may be integrated into a single key module. Thus, it is possible to decrease a number of parts and manufacturing costs. Also, it is possible to perform various functions with a simpler design.

The mobile terminal controlling method according to the above-described exemplary embodiments of the present invention may be recorded in computer-readable media including program instructions to implement various operations when executed by a computer. The media may also include, alone or in combination with the program instructions, data files, data structures, and the like. Examples of computer-readable media include magnetic media such as hard disks, floppy disks, and magnetic tape; optical media such as CD-ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal, comprising:
a case;
a key module to be moveable between a first point and a second point along the case;
a mode identification unit to identify a position of the key module as the first point or the second point, and to identify mode information associated with the position of the key module; and
an application drive unit to drive an application based on the mode information.

2. The mobile terminal of claim 1, further comprising:
a database to register mode information corresponding to the first point and mode information corresponding to the second point,
wherein the mode identification unit identifies mode information registered in the database corresponding to the first point or the second point according to the position of the key module.

3. The mobile terminal of claim 1, wherein the mode identification unit comprises:
a magnetic sensor to sense a magnetic substance included in the key module; and
a time sensor to sense whether the magnetic substance is maintained at the first point or the second point for a predetermined period of time.

4. The mobile terminal of claim 1, wherein if the mode information is identified as a hold mode, the application drive unit drives a hold application, and controls the hold application to display an idle screen in association with an operation of an operation key included in the key module.

5. The mobile terminal of claim 1, wherein if the mode information is identified as a volume mode, the application drive unit drives a volume application, and controls the volume application to increase or decrease a speaker volume in association with an operation of an operation key included in the key module.

6. The mobile terminal of claim 5, wherein if the mode information is identified as a volume mode while the mobile terminal is in an incoming call status, the mobile terminal automatically changes from the incoming call status to a calling/called status.

7. The mobile terminal of claim 1, wherein if the mode information is identified as a photographing mode, the application drive unit drives a photographing application, and controls the photographing application to create an image or to display the image on a screen in association with an operation of an operation key included in the key module.

8. The mobile terminal of claim 1, wherein the key module is further moveable to a third point, and the mode identification unit identifies a position of the key module as the first point, the second point, or the third point.

9. A method for controlling a mobile terminal, comprising:
verifying a position of a moveable key module as a first point or a second point along a case of the mobile terminal;
identifying mode information associated with the position of the moveable key module; and
driving an application based on the mode information.

10. The method of claim 9, further comprising:
maintaining a database to register mode information corresponding to the first point and mode information corresponding to the second point,
wherein identifying mode information comprises identifying mode information registered in the database corresponding to the first point or the second point according to the position of the moveable key module.

11. The method of claim 9, wherein verifying the position comprises:
sensing a magnetic substance included in the moveable key module via a magnetic sensor; and
sensing, via a time sensor associated with the magnetic sensor, whether the magnetic substance is maintained at the first point or the second point for a predetermined period of time.

12. The method of claim 9, wherein if the mode information is identified as a hold mode, the driving comprises driving a hold application, and controlling the hold application to display an idle screen in association with an operation of an operation key included in the moveable key module.

13. The method of claim 9, wherein if the mode information is identified as a volume mode, the driving comprises driving a volume application, and controlling the volume application to increase or decrease a speaker volume in association with an operation of an operation key included in the key module.

14. The method of claim 13, wherein driving the volume application further comprises changing a status of the mobile terminal from an incoming call status to a calling/called status.

15. The method of claim 9, wherein if the mode information is identified as a photographing mode, the driving comprises driving a photographing application, and controlling the photographing application to create an image or to display the image on a screen in association with an operation of an operation key included in the key module.

16. The method of claim 9, wherein verifying further comprises verifying the position of the moveable key module as the first point, the second point, or a third point, and the mode information corresponds to mode information associated with the first point, the second point, or the third point according to the position of the moveable key module.
